(19) United States
(12) Patent Application Publication
(10) Pub. No.: US 2015/0217730 A1
(43) Pub. Date: Aug. 6, 2015

(54) WINDSCREEN WIPER DEVICE

(71) Applicant: Xavier Boland, Arlon (BE)

(72) Inventor: Xavier Boland, Arlon (BE)

(21) Appl. No.: 14/419,137

(22) PCT Filed: Aug. 2, 2012
(86) PCT No.: PCT/EP2012/065197

§ 371 Date: Apr. 14, 2015

(51) Int. Cl. B60S 1/38; B60S 1/40; B60S 1/52

(52) U.S. Cl. CPC B60S 1/3877; B60S 1/524; B60S 1/3808; B60S 1/4048; B60S 2001/3898

(57) ABSTRACT

A windscreen wiper device of the flat blade type includes an elastic, elongated carrier element, as well as an elongated wiper blade of a flexible material, which can be placed in abutment with a windscreen to be wiped. The wiper blade includes one central groove, in which groove a longitudinal strip of the carrier element is disposed. The windscreen wiper device includes a connecting device for an oscillating arm, wherein the oscillating arm can be pivotally connected to the connecting device about a pivot axis near one end. The wiper blade includes a wiping lip at a side of the central groove facing towards a windscreen to be wiped. The wiper blade is made in one piece of elastomeric material. The wiper blade has at least one longitudinal cleaning fluid channel, as well as several holes spaced apart along at least a portion of a length of the wiper blade, and wherein the holes extend obliquely in downward direction from the cleaning fluid channel to the outside for spraying cleaning fluid from the cleaning fluid channel through the holes onto a windscreen to be wiped.

### BACKGROUND OF THE INVENTION

1. Technical Field

The present invention relates to a windscreen wiper device of the flat blade type comprising an elastic, elongated carrier element, as well as an elongated wiper blade of a flexible material, which can be placed in abutment with a windscreen to be wiped, which wiper blade includes one central groove, in which groove a longitudinal strip of the carrier element is disposed, which windscreen wiper device comprises a connecting device for an oscillating arm, wherein the oscillating arm can be pivotally connected to the connecting device about a pivot axis near one end, and wherein the wiper blade includes a wiping lip at a side of the central groove facing towards a windscreen to be wiped.

2. Related Art

Such a windscreen wiper device is generally known. The prior art windscreen wiper device is in particular designed as a “flat blade” or “yokeless blade”, wherein use is no longer made of several yokes pivotally connected to each other, but wherein the wiper blade is biased by the carrier element, as a result of which it exhibits a specific curvature. One drawback of the prior art windscreen wiper device is the fact that a windscreen to be wiped is often not cleaned effectively during one or more so-called “spray cycle(s)”, i.e. when a driver sprays water onto a windscreen of his vehicle and windscreen wiper devices thereof, whether or not activated automatically thereupon, subsequently wipe the windscreen once or twice, particularly in case the windscreen is covered with dirt like insects and the like. The object of the invention is to overcome this drawback of the prior art as indicated above, in particular to provide a windscreen wiper device which allows a windscreen to be wiped effectively at all times.

### SUMMARY OF THE INVENTION

In order to accomplish that objective, a windscreen wiper device of the kind referred to in the introduction is characterized according to the invention in that the wiper blade is made in one piece of elastomeric material, wherein the wiper blade comprises at least one longitudinal cleaning fluid channel, as well as several holes spaced apart along at least a portion of a length of the wiper blade, and wherein the holes extend obliquely in downward direction from the cleaning fluid channel to the outside for spraying cleaning fluid from the cleaning fluid channel through the holes onto a windscreen to be wiped. In other words, the wiper blade—including any spoiler, the wiping lip, the channel and the holes—is made in one piece of elastomeric material, such as rubber, preferably using an extrusion operation. No use is made of separate constructional elements, such as spraying nozzles and/or a single channel of a different material. According to the invention the cleaning fluid channel is made inside the elastomeric material by providing a longitudinal groove or slit therein, particularly through extrusion. Realizing the cleaning fluid channel inside the elastomeric material of the wiper blade has the advantage that, in case of frost, the elastomeric material around the cleaning fluid channel may easily compensate an expansion in volume of frozen water inside the cleaning fluid channel. Further, the elastomeric material is not sensitive to any creep, has a good chemical resistance to any chemicals present in the cleaning fluid, and does not show any deformation as a result of a sudden impact.

the holes extending obliquely in downward direction from the cleaning fluid channel to the outside, i.e. enclosing a sharp angle with the horizontal, has the advantage that the cleaning fluid is uniformly spread over a windscreen to be wiped, while using less cleaning fluid, even at low fluid pressure. Due to the fact that during operation the cleaning fluid exits the holes on the wiper blade at a short distance from a windscreen to be wiped, a period of time between spraying the cleaning fluid on a windscreen to be wiped and subsequently wiping the sprayed cleaning fluid away by the windscreen wiper device(s), is considerably reduced. As a result thereof, better visibility during a so-called “spray cycle” or “wash cycle” is obtained, whereas any negative effect of a high vehicle speed on wiping properties are reduced as well. The wiper blade is preferably made in one piece of elastomeric material through an extrusion process, wherein the holes are preferably made in an extra process step after extruding the wiper blade.

In a preferred embodiment of a windscreen wiper device in accordance with the invention the wiper blade includes a spoiler at a side of the central groove facing away from a windscreen to be wiped, wherein the cleaning fluid channel is located inside the spoiler. Preferably, the cleaning fluid channel is located inside the spoiler near a downstream side thereof, wherein the holes are provided at a downstream side of the wiper blade.

In another preferred embodiment of a windscreen wiper device according to the invention the cleaning fluid channel is located inside a part of the wiper blade that is connected with the wiping lip through a tilting web. Particularly, two cleaning fluid channels are located inside the part of the wiper blade that is connected with the wiping lip through the tilting web, wherein the one cleaning fluid channel is located near the downstream side of the part of the wiper blade, and wherein the other cleaning fluid channel is located near the upstream side of the part of the wiper blade. More in particular, the holes are provided at a downstream side and at an upstream side of the part of the wiper blade.

In another preferred embodiment of a windscreen wiper device in accordance with the invention the cleaning fluid channel is located inside a downstream sidewall of the central groove, wherein the holes are provided at the sidewall. Particularly, two cleaning fluid channels are provided for, wherein the one cleaning fluid channel is located inside the downstream sidewall of the central groove, and wherein the other cleaning fluid channel is located inside an upstream sidewall of the central groove. More in particular, the holes are provided at the downstream sidewall and at the upstream sidewall of the central groove.

In another preferred embodiment of a windscreen wiper device according to the invention the spoiler is provided with a recess for accommodating the connecting device therein, wherein the connecting device is provided with an inlet for allowing cleaning fluid to enter the cleaning fluid channel. In the alternative or in addition thereto the cleaning fluid channel(s) is/are provided with an inlet at the location of a free end of the wiper blade for allowing cleaning fluid to enter the cleaning fluid channel.

The present invention also refers to a method for manufacturing a windscreen wiper device of the flat blade type comprising an elastic, elongated carrier element, as well as an elongated wiper blade of a flexible material, which can be placed in abutment with a windscreen to be wiped, which wiper blade includes one central groove, in which groove a longitudinal strip of the carrier element is disposed, which windscreen wiper device comprises a connecting device for an oscillating arm, wherein the oscillating arm can be pivotally connected to the connecting device about a pivot axis near one end, and wherein the wiper blade includes a spoiler at a side of the central groove facing away from a windscreen to be wiped, as well as a wiping lip at a side of the central groove facing towards a windscreen to be wiped, characterized in that the wiper blade is made in one piece of elastomeric material, wherein the wiper blade comprises at least one longitudinal cleaning fluid channel, as well as several holes spaced apart along at least a portion of a length of the wiper blade, and wherein the holes extend obliquely in downward direction from the cleaning fluid channel to the outside for spraying cleaning fluid from the cleaning fluid channel through the holes onto a windscreen to be wiped.

### THE DRAWINGS

The invention will now be explained in more detail with reference to figures illustrated in a drawing, wherein:

FIG. 1 is a perspective, schematic view of a windscreen wiper device in accordance with the invention;

FIG. 2 is a perspective, schematic view of a wiper blade used in the windscreen wiper device of FIG. 1 according to a first embodiment, together with a side view and a cross-sectional view along the line B-B thereof; and

FIGS. 3, 4 and 5 correspond to FIG. 2, but now relating to a second, third and fourth embodiment of a wiper blade to be used in the windscreen wiper device of FIG. 1, respectively.

### DETAILED DESCRIPTION

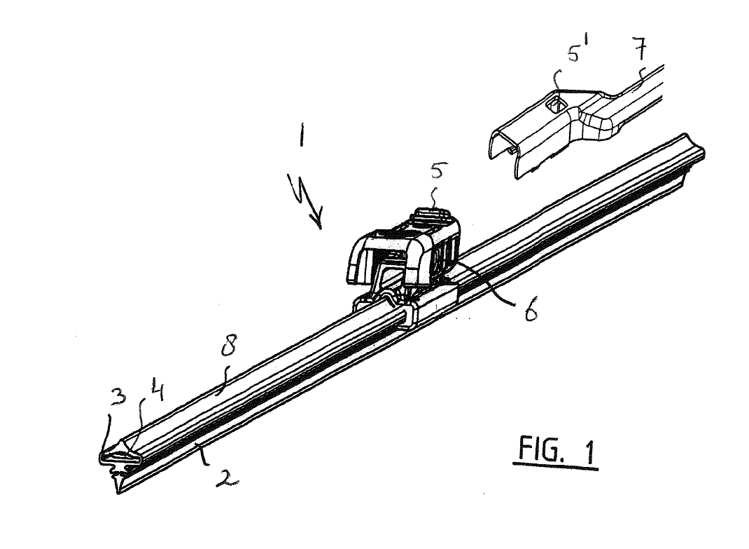

FIG. 1 shows a preferred variant of a windscreen wiper device 1 according to the invention. the windscreen wiper device 1 is built up of an elongated wiper blade 2 made of an elastomeric material. the wiper blade 2 comprises a central longitudinal groove 3, in which a longitudinal strip 4 or flexor made of spring band steel is fitted. the strip 4 forms a flexible carrier element for the rubber wiper blade 2, as it were, which is thus biased in a curved position (the curvature in operative position being that of a windscreen to be wiped). The windscreen wiper device 1 is further equipped with a connecting device 6 for an oscillating arm 7. In this respect use is made of a so-called bayonet connection wherein a resilient tongue 5 on the connecting device 6 is snapped in a corresponding shaped hole 5′ in the oscillating arm 7.

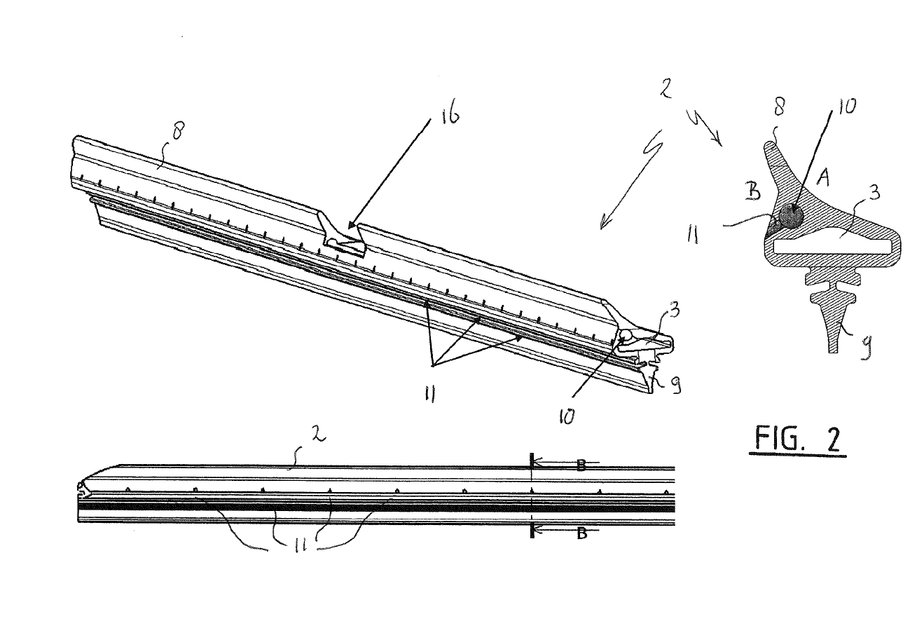

With reference to FIG. 2, the wiper blade 2 includes a spoiler 8 in one piece therewith at a side of the central groove 3 facing away from a windscreen to be wiped, as well as a wiping lip 9 at a side of the central groove 3 facing towards a windscreen to be wiped. As indicated earlier, the wiper blade 2 is made in one piece of elastomeric material through an extrusion process, preferably rubber, wherein the wiper blade 2 includes one longitudinal cleaning fluid channel 10, as well as several holes 11 spaced apart along at least a portion of a length of the wiper blade 2. the holes 11 extend obliquely in downward direction from the cleaning fluid channel (10) to the outside for spraying cleaning fluid from the cleaning fluid channel through the holes 11 onto a windscreen to be wiped. As shown, the cleaning fluid channel 10 is located inside the spoiler 8 near a downstream side B thereof, wherein the holes 11 are also provided at the downstream side B of the wiper blade 2.

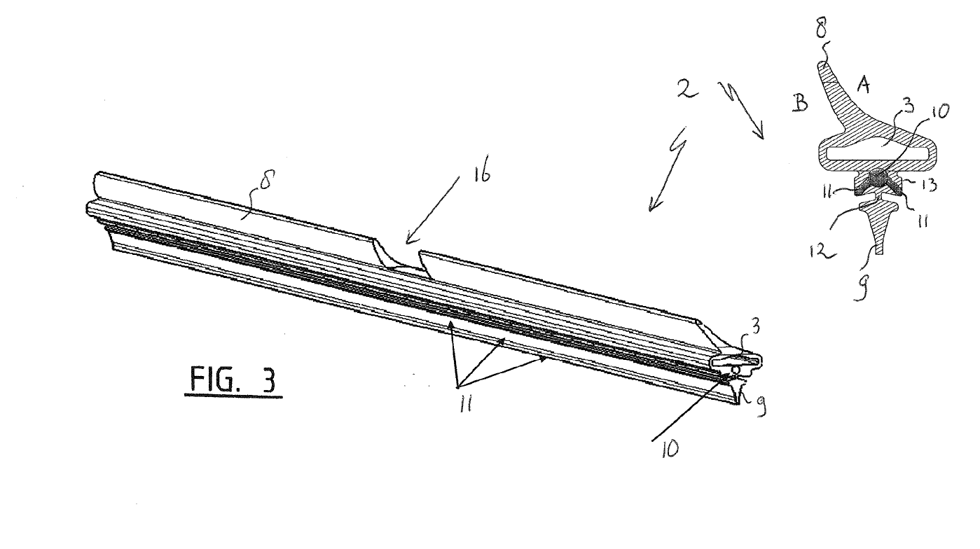

FIGS. 3, 4 and 5 correspond to FIG. 2, wherein corresponding parts have been designated with the same reference numerals.

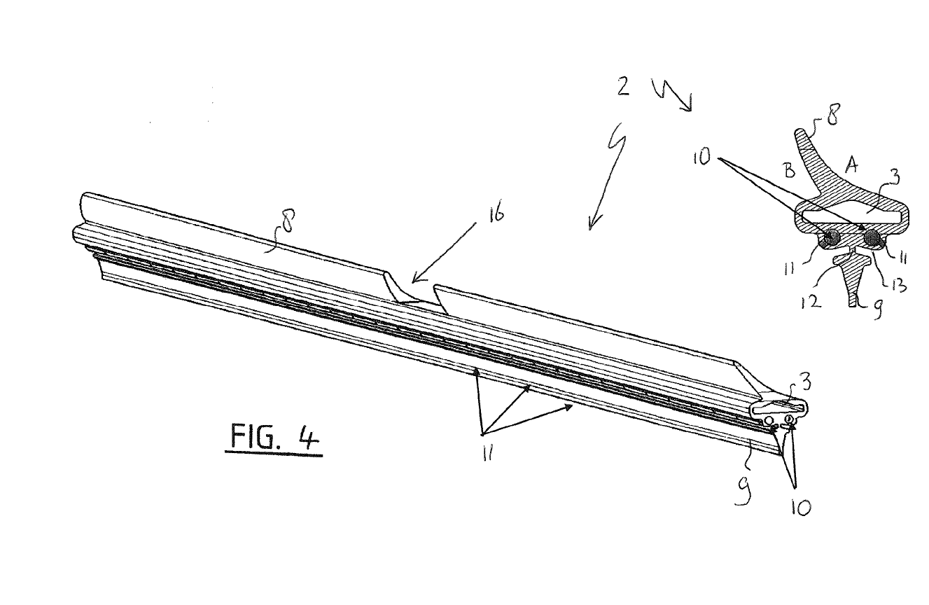

As shown in FIG. 3, the cleaning fluid channel 10 is now located inside a part 13 of the wiper blade 2 that is connected with the wiping lip 9 through a tilting web 12. the holes 11 are provided at a downstream side B and at an upstream side A of the part 13 of the wiper blade 2. With reference to FIG. 4, two cleaning fluid channels 10 are now located inside the part 13 of the wiper blade 2 that is connected with the wiping lip 9 through the tilting web 12. The one cleaning fluid channel 10 is located near the downstream side B of the part 13 of the wiper blade 2, wherein the other cleaning fluid channel 10 is located near the upstream side of the part 13 of the wiper blade 2. Again, the holes 11 are provided at a downstream side B and at an upstream side A of the part 13 of the wiper blade 2.

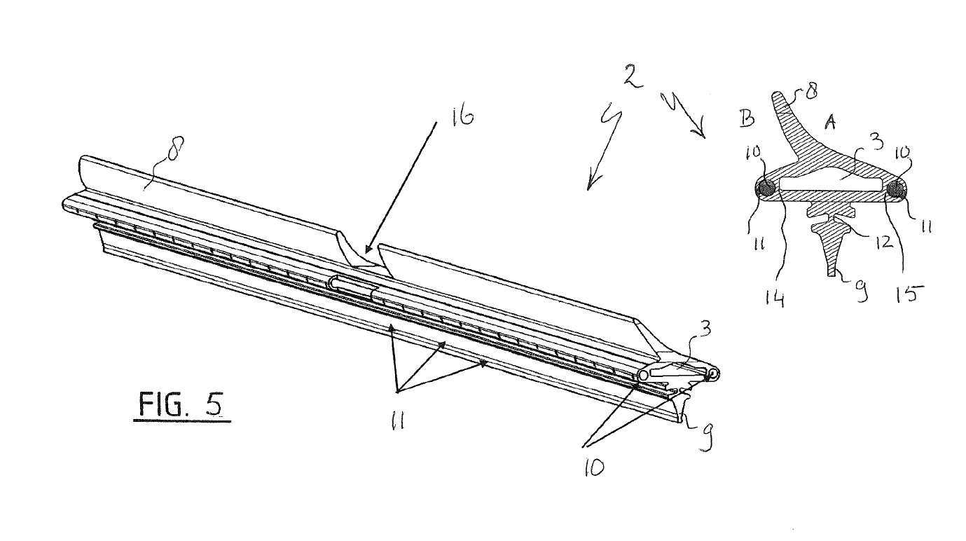

As depicted in FIG. 5, two cleaning fluid channels 10 are now again present, wherein the one cleaning fluid channel 10 is located inside the downstream sidewall 14 of the central groove 3, wherein the other cleaning fluid channel 10 is located inside an upstream sidewall 15 of the central groove 3. the holes 11 are provided at the downstream sidewall 14 and at the upstream sidewall 15 of the central groove 3.

The spoiler 8 is removed along a portion of the length of the wiper blade 2 at a distance from free ends of the wiper blade 2 facing the end caps 5, so as to form a longitudinal cut-out or recess 16. In case the connecting device 6 is provided with an inlet for allowing cleaning fluid to enter the cleaning fluid channel (s) 10, mounting of connecting device 6 into the recess 16 of the wiper blade 2 is arranged in such a manner that the inlet is in fluid connection with the cleaning fluid channel (10). Although not shown in FIG. 1, but fully understood by a skilled person, the oscillating arm 7 is connected to a mounting head fixed for rotation to a shaft driven by a small motor. In use, the shaft rotates alternately in a clockwise and in a counter-clockwise sense carrying the mounting head into rotation also, which in turn draws the oscillating arm 7 into rotation and by means of the connecting device 6 moves the wiper blade 2.

The invention is not restricted to the embodiments shown, but also extends to other preferred embodiments falling within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes one central groove, in which groove a longitudinal strip of the carrier element is disposed, which windscreen wiper device comprises a connecting device for an oscillating arm, wherein said oscillating arm can be pivotally connected to said connecting device about a pivot axis near one end, and wherein said wiper blade includes a wiping lip at a side of said central groove facing towards a windscreen to be wiped, wherein said wiper blade is made in one piece of elastomeric material, wherein said wiper blade comprises at least one longitudinal cleaning fluid channel, as well as several holes spaced apart along at least a portion of a length of said wiper blade, and wherein said holes extend obliquely in downward direction from said cleaning fluid channel to the outside for spraying cleaning fluid from said cleaning fluid channel through said holes onto a windscreen to be wiped.

2. The windscreen wiper device according to claim 1, wherein said wiper blade includes a spoiler at a side of said central groove facing away from a windscreen to be wiped, and wherein said cleaning fluid channel is located inside said spoiler.

3. The windscreen wiper device according to claim 2, wherein said cleaning fluid channel is located inside said spoiler near a downstream side thereof, and wherein said holes are provided at a downstream side of said wiper blade.

4. The windscreen wiper device according to claim 1, wherein said cleaning fluid channel is located inside a part of said wiper blade that is connected with said wiping lip through a tilting web.

5. The windscreen wiper device according to claim 4, wherein two cleaning fluid channels are located inside said part of said wiper blade that is connected with said wiping lip through said tilting web, wherein the one cleaning fluid channel is located near the downstream side of said part of said wiper blade, and wherein the other cleaning fluid channel is located near the upstream side of said part of said wiper blade.

6. The windscreen wiper device according to claim 4, wherein said holes are provided at a downstream side and at an upstream side of said part of said wiper blade.

7. The windscreen wiper device according to claim 1, wherein said cleaning fluid channel is located inside a downstream sidewall of said central groove, and wherein said holes are provided at said sidewall.

8. The windscreen wiper device according to claim 7, wherein two cleaning fluid channels are present, wherein the one cleaning fluid channel is located inside said downstream sidewall of said central groove, and wherein the other cleaning fluid channel is located inside an upstream sidewall of said central groove.

9. The windscreen wiper device according to claim 8, wherein said holes are provided at said downstream sidewall and at said upstream sidewall of said central groove.

10. The windscreen wiper device according to claim 2, wherein said spoiler is provided with a recess for accommodating said connecting device therein, and wherein said connecting device is provided with an inlet for allowing cleaning fluid to enter said cleaning fluid channel.

11. The windscreen wiper device according to claim 1, wherein said at least one cleaning fluid channel is provided with an inlet at the location of a free end of said wiper blade for allowing cleaning fluid to enter said at least one cleaning fluid channel.

12. Method for manufacturing a windscreen wiper device of the flat blade type including preparing an elastic, elongated carrier element, as well as an elongated wiper blade of a flexible material, which can be placed in abutment with a windscreen to be wiped, which wiper blade includes one central groove, in which groove a longitudinal strip of the carrier element is disposed, which windscreen wiper device comprises a connecting device for an oscillating arm, wherein said oscillating arm can be pivotally connected to said connecting device about a pivot axis near one end, and wherein said wiper bladeis formed with a wiping lip at a side of said central groove facing towards a windscreen to be wiped, and wherein said wiper blade is made in one piece of elastomeric material, wherein said wiper blade is provided with at least one longitudinal cleaning fluid channel, as well as with several holes spaced apart along at least a portion of a length of said wiper blade, and wherein said holes are formed to extend obliquely in downward direction from said cleaning fluid channel to the outside for spraying cleaning fluid from said cleaning fluid channel through said holes onto a windscreen to be wiped.
